(19) United States
(12) Patent Application Publication
(10) Pub. No.: US 2024/0428106 A1
(43) Pub. Date: Dec. 26, 2024

(54) Adaptive Diversity-Based Quantum Circuit Architecture Search

(71) Applicant: HSBC Software Development (Guangdong) Limited, Guangzhou (CN)

(72) Inventors: Bing Zhu, Shanghai (CN); Ziyuan Li, Guangzhou (CN); Yong Xia, Shanghai (CN); Qiming Shao, Hong Kong (CN); Yuhan Huang, Hong Kong (CN); Siyuan Jin, Hong Kong (CN)

(73) Assignee: HSBC Software Development (Guangdong) Limited, Guangzhou (CN)

(21) Appl. No.: 18/519,617

(22) Filed: Nov. 27, 2023

(51) Int. Cl. G06N 10/20

(52) U.S. Cl. CPC G06N 10/20

(57) ABSTRACT

A computing system for generating a quantum circuit. The computing system samples a search space for candidate quantum circuits for a circuit layer of a quantum circuit design. The computing system evaluates performance of the candidate quantum circuits for the circuit layer. The computing system selects one of the candidate quantum circuits for the circuit layer based on the evaluated performance, adds an additional circuit layer based on the quantum circuit design to the selected one of the candidate quantum circuits.

### FIELD OF THE DISCLOSURE

The present disclosure generally relates to a system and method for designing efficient quantum circuits.

### BACKGROUND

Quantum computing is a rising growing field. Currently, performance of quantum computers is limited due to issues including the use of fixed coupling maps between qbits (or qubits) and depolarizing noise. This leads to quantum circuit designs that are deficient in terms of performance and efficiency.

### SUMMARY

In some embodiments, a method for generating quantum circuits is disclosed herein. The method includes sampling, by a processor, a search space for candidate quantum circuits for a circuit layer of a quantum circuit design, evaluating, by the processor, performance of the candidate quantum circuits for the circuit layer, selecting, by the processor, one of the candidate quantum circuits for the circuit layer based on the evaluated performance, and adding, by the processor, an additional circuit layer based on the quantum circuit design to the selected one of the candidate quantum circuits.

In some embodiments, a non-transitory computer readable medium is disclosed herein. The non-transitory computer readable medium includes one or more sequences of instructions, which, when executed by one or more processors, causes a computing system to perform operations for generating quantum circuits. The operations include sampling, by the computing system, a search space for candidate quantum circuits for a circuit layer of a quantum circuit design, evaluating, by the computing system, performance of the candidate quantum circuits for the circuit layer, selecting, by the computing system, one of the candidate quantum circuits for the circuit layer based on the evaluated performance, and adding, by the computing system, an additional circuit layer based on the quantum circuit design to the selected one of the candidate quantum circuits.

In some embodiments, a system is disclosed herein. The system includes a processor and a memory. The memory has programming instructions stored thereon, which, when executed by the processor, causes the system to perform operations for generating quantum circuits. The operations include sampling, by the system, a search space for candidate quantum circuits for a circuit layer of a quantum circuit design, evaluating, by the system, performance of the candidate quantum circuits for the circuit layer, selecting, by the system, one of the candidate quantum circuits for the circuit layer based on the evaluated performance, and adding, by the system, an additional circuit layer based on the quantum circuit design to the selected one of the candidate quantum circuits.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a flow diagram illustrating an architecture search method for designing quantum circuits, according to example embodiments.

FIG. 3A is a block diagram illustrating a Variational Quantum Eigensolver, according to example embodiments.

FIG. 3B is a block diagram illustrating a Variational Quantum Classifier, according to example embodiments.

FIG. 4 is a diagram illustrating an IBM-Lima quantum device, according to example embodiments.

FIG. 5A is a block diagram illustrating an adaptive diversity-based quantum architecture search method, according to example embodiments.

FIG. 5B is a flow diagram illustrating an adaptive diversity-based quantum architecture search method, according to example embodiments.

FIG. 6A is a block diagram illustrating an optimized hardware efficient ansatz, according to example embodiments.

FIG. 6B is a block diagram illustrating an optimized quantum circuit, according to example embodiments.

FIG. 6C is a block diagram illustrating an optimized hardware efficient ansatz and an optimized hardware efficient quantum circuit for the use case of credit card fraud detection, according to example embodiments.

FIG. 6D is a block diagram illustrating an optimized hardware efficient ansatz and an optimized hardware efficient quantum circuit for the use case of credit card fraud detection, according to example embodiments.

FIG. 6E is a block diagram illustrating an optimized hardware efficient ansatz and an optimized hardware efficient quantum circuit for use case of Iris classification, according to example embodiments.

FIG. 6F is a block diagram illustrating an optimized hardware efficient ansatz and an optimized hardware efficient quantum circuit for use case of Iris classification, according to example embodiments.

FIG. 7A is a block diagram illustrating a computing device, according to example embodiments.

FIG. 7B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein provides a mechanism for generating quantum circuits that are optimized to achieve a desired functionality while requiring fewer quantum and classical resources. More specifically, one or more techniques disclosed herein provide a tool that leverages machine learning in the circuit design process to generate an optimized circuit for achieving a desired function.

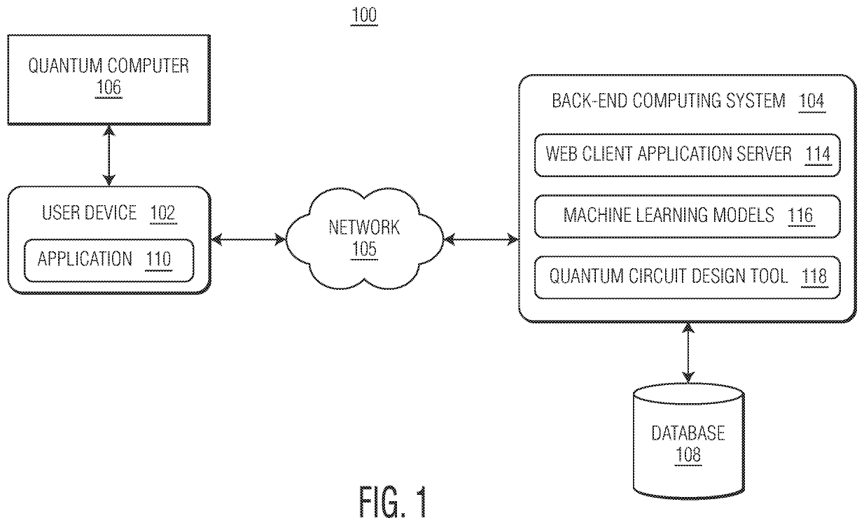

FIG. 1 is a block diagram illustrating a computing environment 100, according to example embodiments. Computing environment 100 may include quantum computer 106 and classical computers such as user device 102, back-end computing system 104 and communicating via network 105. The quantum circuit design process is generally performed by the classical computers, which may then be interfaced with the resultant quantum computer 106, which may take the form of the quantum circuit(s) designed by the classical computers. In other words, the classical computers design the quantum circuits that make up the structure of quantum computer 106. These classical computers may then be used in conjunction with quantum computer 106 to perform hybrid classical/quantum applications for various use cases.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

User device 102 may be in communication with back-end computing system 104 via network 105. User device 102 may be operated by a user. For example, user device 102 may be a mobile device, a tablet, a desktop computer, or any computing system having the capabilities described herein. In some embodiments, users may include, but are not limited to, individuals such as, for example, developers or employees of an entity associated with back-end computing system 104. In some embodiments, users may include, but are not limited to, individuals, such as, for example, subscribers or customers of an entity associated with back-end computing system 104.

User device 102 may include application 110. Application 110 may be representative of an application associated with back-end computing system 104. In some embodiments, application 110 may be a standalone application associated with back-end computing system 104. In some embodiments, application 110 may be representative of a web-browser configured to communicate with back-end computing system 104. In some embodiments, user device 102 may communicate over network 105 to request a webpage, for example, from web client application server 114 of back-end computing system 104. For example, user device 102 may be configured to execute application 110 to design an optimized quantum circuit. The content that is displayed to user device 102 may be transmitted from web client application server 114 to user device 102, and subsequently processed by application 110 for display through a graphical user interface (GUI) of user device 102.

Back-end computing system 104 may include web client application server 114, machine learning models 116, and quantum circuit design tool 118. Quantum circuit design tool 118 may be comprised of one or more software modules for facilitating a quantum circuit design process by utilizing machine learning models 116. The one or more software modules may be collections of code or instructions stored on a media (e.g., memory of back-end computing system 104) that represent a series of machine instructions (e.g., program code) that implements one or more algorithmic steps. Such machine instructions may be the actual computer code the processor of back-end computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Machine learning models 116 may be representative of one or more machine learning models used by quantum circuit design tool 118. In some embodiments, machine learning models 116 may include a machine learning model trained to predict layers of a quantum circuit based on functional design parameters.

In some embodiments, back-end computing system 104 may maintain or be in communication with database 108. In some embodiments, database 108 may maintain data used for training machine learning models 116. In some embodiments, database 108 may maintain data used for generating decisions using machine learning models 116. For example, database 108 may include information related to customers or subscribers of an entity associated with back-end computing system 104.

Certain applications may benefit from certain types of quantum circuit designs. In other words, it may be beneficial to design the quantum circuit according to the application that the quantum circuit is ultimately being utilized for. Information germane to these applications may be used, for example, in the machine learning process to select an optimal quantum circuit for a given application. To support such an operation, database 108 may include information germane to applications of the quantum circuits. This allows the system to utilize information as functional parameters for training the machine learning model to accurately predict layers of a quantum circuit. Therefore, the system not only predicts an efficient quantum circuit, but also ensures that the quantum circuit is optimized for a particular application.

In one example, if the application of the quantum circuit is related to monitoring/manipulating financial transactions, database 108 may include transaction data such as details of financial transactions made by customers (e.g., transaction amount, date, time, merchant information, payment method, and transaction location). In another example, if the application of the quantum circuit is related to monitoring/manipulating customer behavior, database 108 may include user behavior data such as data on customer behavior patterns (e.g., browsing history, login/logout times, session duration, and interaction with various features or service). In yet another example, if the application of the quantum circuit is related to monitoring/manipulating hardware devices being utilized by customers, database 108 may include device information which may include data related to the devices used by customers (e.g., device type, operating system, IP address, and geolocation). In yet another example, if the application of the quantum circuit is related to monitoring/manipulating risk information in financial transactions, database 108 may include risk information which may include risk indicators (e.g., velocity, velocity of money transfer, and previous fraud history). In other words, the data stored in database 108 and ultimately used for training the model is selected for the application that the circuit is being designed to execute.

In some embodiments, user device 102 may be a standalone computer for designing quantum circuits. For example, user device 102 may execute an application that performs all the computations (e.g., sampling, machine learning, etc.) to perform quantum circuit design. In other words, user device 102 may include the machine learning models 116 and quantum circuit design tool 118.

As an overview, quantum computers utilize principles of quantum mechanics to perform complex calculations using circuits comprised from physical systems (e.g., ions, etc.). Unlike classical computers that use classical bits that represent either a 0 state (i.e., |0>) or a 1 state (i.e., |1>), quantum computers use quantum bits (qbits) which may also exist in a superposition of states. In other words, qbits can represent either |0>, |1> or both a |0> and |1> simultaneously. This superposition property provides an advantage over classical computers because it allows quantum computers to perform parallel and simultaneous computations of various states thereby increasing processing speed significantly. In addition to superposition, qbits may be entangled with one another such that when a bit changes, an entangled bit also changes. This entanglement property is beneficial because it allows quantum computers to perform computations that are not possible with classical computers. In other words, quantum computers have various properties that facilitate increased processing power and capabilities that cannot be achieved by classical computers.

Furthermore, quantum computers are generally constructed as a system of quantum circuits having various stages of operation including initialization of qbits, manipulation of qbits and measurement of qbits. More specifically, the quantum circuits include a sequence of quantum gates operating on the qbits. Like classical logic gates utilized by classical computers, quantum gates also control the states of qbits to achieve a desired functionality. To name a few, quantum gates include but are not limited to Pauli Gates for performing rotations and flips around the X, Y and Z axes, Hadamard Gates for creating superposition, Phase Gates for phase shifting qbits, CNOT Gates for performing NOT operations, Toffoli Gates for performing controlled-controlled-NOT operations, SWAP gates for exchanging states between qbits, and controlled phase Gates for phase shifting a target qbit.

Given the number of possible quantum gates and circuit configurations, it is apparent that a desired function can be achieved by various quantum circuit configurations. However, each various quantum circuit configuration may have different performance in terms of the number of gates utilized, power consumed and other metrics. Therefore, it would be beneficial to design a quantum circuit not only achieve a desired functionality, but also to be optimized for minimizing the use of quantum gates, power consumption, latency, etc. The systems/methods described herein are focused on a quantum circuit design process performed by a classical computer with this and other goals in mind.

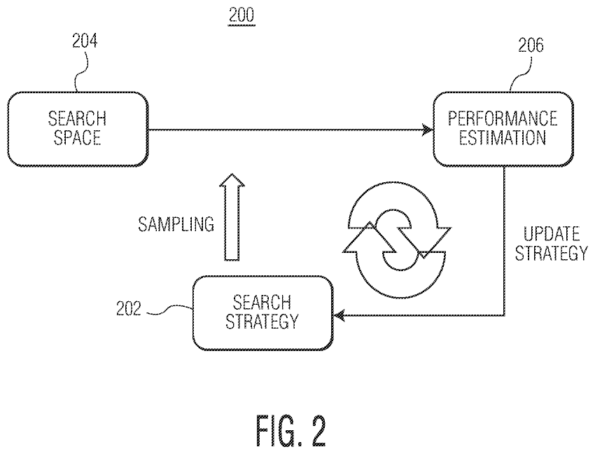

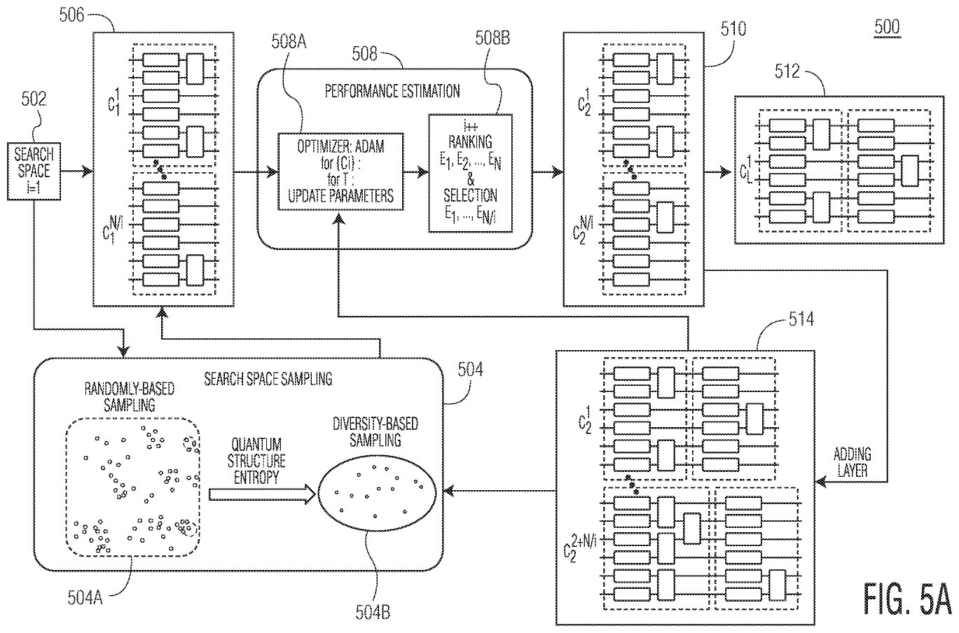

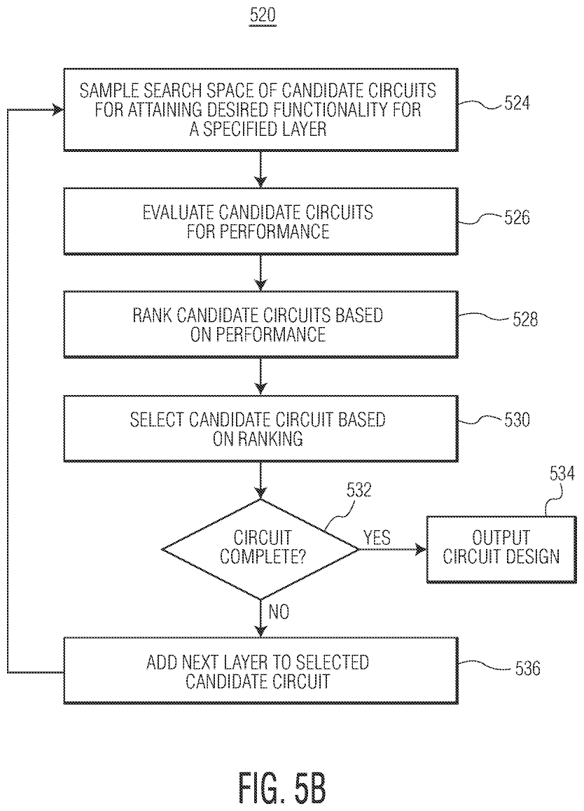

FIG. 2 is a flow diagram 200 illustrating an architecture search method for designing quantum circuits, according to example embodiments. The overall search method includes two primary steps that are performed by user device 102, back-end computing system 104 or a combination of both at each layer in the sequence of designing a quantum circuit. More specifically, user device 102 and/or back-end computing system 104 execute quantum circuit design tool 118 that utilizes machine learning models 116 to facilitate the quantum circuit design process. In a first step 202, user device 102 may execute a search strategy to search a search space 204 for a possible arrangement of quantum gates for designing each layer of the quantum circuit. The search strategy executed by user device 102 and/or back-end computing system 104, for example, may be a random search that randomly selects a number of quantum gate arrangements from pool of candidate quantum gate arrangements to achieve the desired function in the circuit layer. In another example, the search strategy may be partially based on desired hardware parameters such as types of gates to be used in the circuit design, etc. For example, search space 204 may include numerous possible arrangements of quantum gates and qbit/gate connections for achieving a desired functionality on the available qbits. Sampling (e.g., random sampling) may be performed by user device 102 and/or back-end computing system 104 to select a subset of candidate arrangements of quantum gates for a given layer in the circuit sequence. This selected subset of candidate arrangements may then be evaluated by user device 102 and/or back-end computing system 104 for performance in performance estimation step 206. Performance estimation and evaluation may include optimizing, ranking and selecting the best circuit layer candidate from the subset of candidate arrangements. More specifically, the ranking may be focused on achieving an overall quantum circuit design that utilizes a minimal number of quantum gates, minimizes power consumption, minimizes latency or a combination of all three. Once the process is completed, user device 102 and/or back-end computing system 104 may compare the best candidates to one another to determine select the optimal candidate for inclusion in the layer of the sequence of the quantum circuit. This process is then repeated by user device 102 and/or back-end computing system 104 at each layer of the sequence of the quantum circuit design until the quantum circuit is complete. In other words, each time the process is repeated, a new layer is added to the previously designed layer and the search strategy is updated. More details of this design method are described with reference to FIGS. 5A and 5B below.

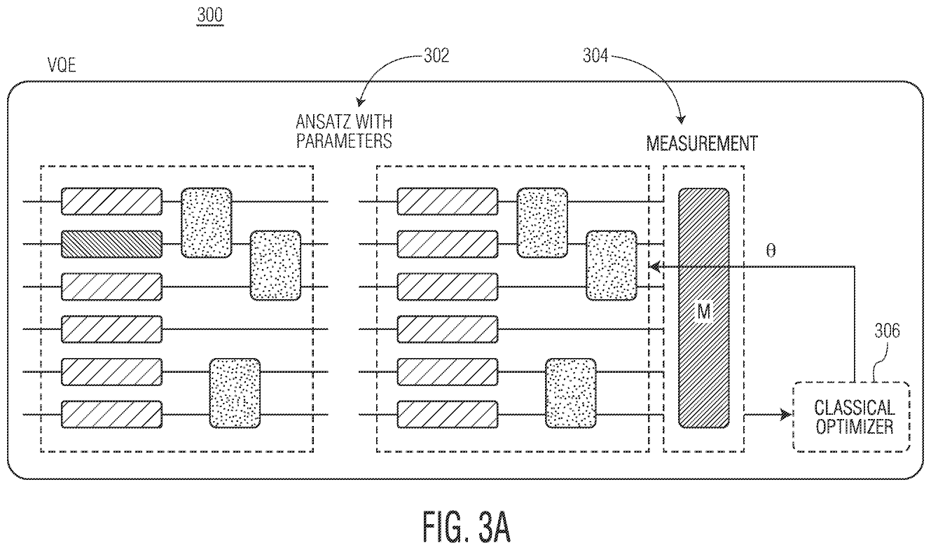

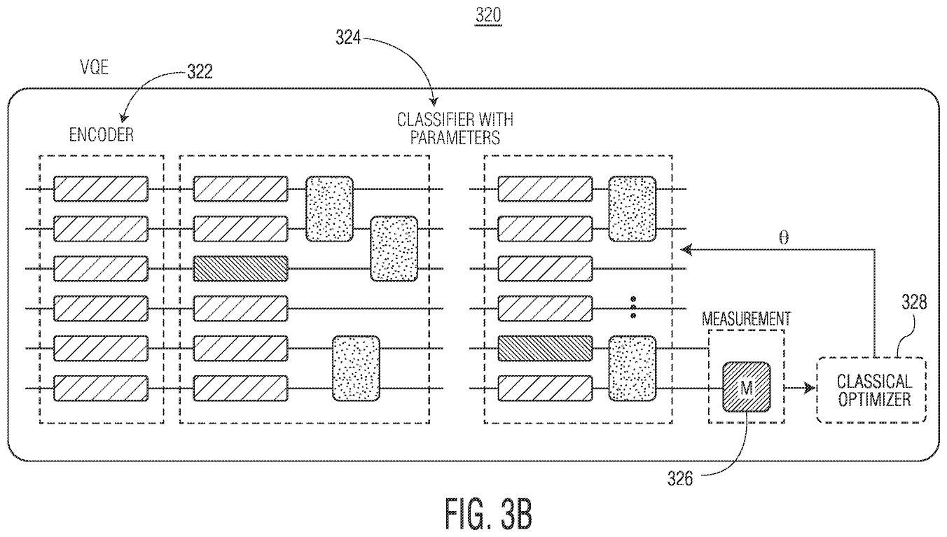

Quantum computers are powerful tools that can be utilized to solve difficult problems that classical computers alone cannot solve. Sometimes quantum computers are used in conjunction with classical computers in classical/hybrid solutions where the quantum computers have adjustable parameters controlled by a classical computer. Two examples of such hybrid solutions are the variational quantum Eigensolver (VQE), and the variational quantum classifier (VQC) described with respect to FIGS. 3A and 3B.

FIG. 3A is a block diagram 300 illustrating VQE, according to example embodiments. VQE is an algorithm that determines the ground state energy of a quantum system with the aid of a classical computer. VQE minimizes the value of a function by varying the parameters of the wave function in equation (1) below:

$$E ( x ) = {min}_{x} \frac{〈 {ϕ}_{0} \vert U ( x ) {HU}^{†} ( x ) \vert {ϕ}_{0} 〉}{〈 {ϕ}_{0} \vert U ( x ) {U}^{†} ( x ) \vert {ϕ}_{0} 〉} \qquad Equation 1$$

The initial state |ϕ₀ [symbol] is typically initialized 1000 . . . 0 [symbol] in the VQE algorithm. Then, through the unitary evolution U(x), the final state is evaluated as |ϕₓ [symbol] . The measurement operation is then used to determine the classical result [symbol] ϕₓ|H|ϕₓ [symbol] . The VQE inputs the classical result into the classical optimizer, such as adaptive moment estimation (ADAM), gradient descent or the like to optimize the parameters x of the quantum evolution, and the process is repeated.

VQE is typically useful in applications such as chemistry and material science. The basic structure of the VQE includes a quantum circuit with an initialization stage to initialize the qbits, an ansatz stage 302 that includes a signal function that represents the approximate ground state, and a measurement stage 304 where the qbits are measured. The classical computer 306 then performs optimization on the measured qbits to adjust the ansatz stage parameters. This process is repeated until optimized ansatz parameters are achieved.

FIG. 3B is a block diagram 320 illustrating a variational quantum classifier, according to example embodiments. VQC is an algorithm that classifies data with the aid of a classical computer 328. VQC is useful in classification applications (e.g., classification of images, data structures, etc.) and includes two primary processes: a learning process to learn from existing observations and a prediction process to estimate new observations. The VQC assumes that the existing observations (data set) are represented as D=(xᵢ, yᵢ)ᵢ₌₁^{M}, where xᵢ∈Rⁿ is a vector of data features and yᵢ∈0, . . . , k is a data label indicating the class to which the data |xᵢ [symbol] belongs. VQC can encode the data features into a quantum state |xᵢ [symbol] using either the amplitude encoding method or the angle encoding method. After data encoding. VQC designs a quantum classifier U(θ) to evaluate. The data encoding and evolution process U(θ) can be viewed as a unified classifier G (x, θ). To classify the data set, VQC may use a measurement operator with a log K-dimensional space, according to the total number of classes k. Based on the measurement result, the data set can be classified into yᵢ′. VQC then uses a classical optimizer to optimize the parameters θ in equation 2 below:

$$L ( θ ) = Σ ‖ {y}_{i} - 〈 ϕ ( {x}_{i} , θ ) \vert O \vert ϕ ( {x}_{i} , θ ) 〉 {\vert}^{2} \\ where \vert ϕ ( {x}_{i} , θ ) 〉 = G ( {x}_{i} , θ ) \vert 0 〉 . \qquad Equation 2$$

The VQC is trained to make predictions by iteratively adjusting its parameters using a classical optimizer until it converges. The basic structure of the VQCE includes a quantum circuit with an initialization stage to initialize the qbits, an encoder stage 322 to encode the data prior to classification, an ansatz stage 324 that includes a quantum feature map for mapping the qbits to a classification, and a measurement stage 326 where the classified qbits are measured. The classical computer 328 then performs optimization on the measured qbits to adjust the ansatz stage classifier parameters. This process is repeated until optimized ansatz parameters are achieved.

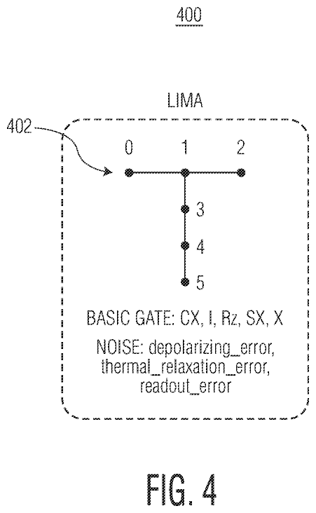

Design of quantum circuits can be performed using different quantum architectures. One such architecture is shown in diagram 400 of FIG. 4 which illustrates a coupling map of an IBM-Lima quantum device, according to example embodiments. In this example, IBM-Lima quantum device 402 includes six nodes representing six interconnected qbits. The coupling map of IBM-Lima quantum device 402 specifies the connectivity of the qbits to a set of basic quantum gates that serve as building blocks for constructing quantum circuits. IBM-Lima includes noise model that describes the sources of noise that can affect the device. Although IBM-Lima is described herein, it is noted that other quantum computers and their associated coupling maps may be used for the design process.

Now that the basic building blocks of quantum circuits and some use cases have been described, the details of the algorithm shown in FIG. 2 are now described with respect to FIG. 5A which shows a block diagram 500 illustrating an adaptive diversity-based quantum architecture search method performed by the classical computer (e.g., user device 102, back-end computing system 104 or a combination of both), according to example embodiments. In general, user device 102 and/or back-end computing system 104 may execute quantum circuit design tool 118 that utilizes machine learning models 116 to facilitate the quantum circuit design process.

As described above with respect to FIG. 2, the architecture search method for designing quantum circuits includes a search step and a performance estimation step. Search step 504 in FIG. 5A includes user device 102 and/or back-end computing system 104 sampling (e.g., randomly sampling) a subset of possible quantum gate configurations for a present layer in the quantum circuit being designed. More specifically, a sample 504A of a possible search space 502 is performed by user device 102 and/or back-end computing system 104 according to the search strategy. These samples are then further filtered by user device 102 and/or back-end computing system 104 possibly using quantum structure entropy or another metric to produce diversity-based samples 504B. In other words, the search space is sampled to ensure a sample 504B of possible quantum gate configurations having a broad range of variation and reduced bias to achieve a specified layer functionality. This can be achieved through various sampling techniques such as clustering sampling, greedy sampling and coverage sampling or the like. The search space is effectively narrowed down to a set of quantum circuits using quantum architecture entropy. These circuits are labeled Cᵢ¹, . . . , Cᵢ^{N}/i, where Cᵢ^{j} represents the jth quantum circuit in the ith generation. In either case, the samples 504B for the given layer being designed is input to the performance estimation step as selected candidate subset 506.

In the performance estimation step 508, the selected subset 506 is operated on by optimizer 508A executing on user device 102 and/or back-end computing system 104. Optimizer 508A may be an adaptive moment estimation (ADAM) algorithm or the like. For example, the ADAM algorithm is used in deep learning for training neural networks. The steps may include calculation of gradients, updating moments, performing bias correction and updating parameters for candidate quantum circuits 506. In other words, optimizer 508A determines how each of the candidates performs according to a given metric (e.g., gate minimization, energy minimization, etc.). For example, in step 508A, the system optimizes N/i circuits using, for example, the ADAM optimizer and sets the iteration count to T. The ADAM optimizer is a gradient descent algorithm that combines momentum and adaptive learning rate features to effectively optimize model parameters. During each iteration, the system calculates the gradients for N/i circuits and updates their parameters. Effectively, the ADAM optimizer dynamically adjusts the learning rate based on the current and previous gradients, allowing for faster convergence to the optimal solution. The choice of iteration count depends on the specific application and other circuit requirements. A larger iteration count can provide more optimization opportunities but may also increase computational time. Thus, an appropriate iteration count T is chosen to strike a balance between optimization and computational time.

The quantum circuits are then ranked by user device 102 and/or back-end computing system 104 according to their performance and selected according to their ranking in step 508B. In general, the top N/(i+1) quantum circuits 510 with the best performance are retained through optimization, ranking, and selection. In other words, the output of the machine learning algorithm is ranked, and a subset of the highest ranked (i.e., best performing) output circuits are selected for further processing through potentially another iteration of the learning process. More specifically, the learning procedure considers diversity of circuits and therefore multiple candidate circuits from 510 are selected and fed back to block 514. Diversity of circuits is beneficial to the learning process because even though circuits may have slightly lower performance during early iterations of the learning process, once additional layers of complexity are added, these lower performing circuits could potentially become high performing (i.e., the best circuits) in later iterations. In other words, performance of circuits may increase or decrease with each iteration and therefore the true performance of the circuits is not fully known until the learning process is complete. By exploring a range of candidate circuits with varying performance levels, the solution ensures that the best performing circuits are not overlooked due to poor initial performance. This approach allows for the consideration of potential improvement and optimization that may arise from circuits with initially lower performance metrics.

After the best quantum circuits 510 are retained, the algorithm adds another layer of complexity at step 514 by considering the diversity of the next layer of candidate quantum circuits. In other words, user device 102 and/or back-end computing system 104 updates the search strategy based on selected quantum circuits 510 of the first layer, a second layer of possible candidates 506 in the quantum circuit is added and the process is repeated to design the second layer. After N repetitions, the output of the algorithm is the optimal quantum circuit 512 having N layers of quantum gates. In other words, after each layer of selecting the best circuit layers 510, another unknown layer is added to the design and determined through sampling and performance estimation. The optimum quantum circuit is therefore built one layer at a time in sequence where each new layer in the design depends on the performance of the selected design in the prior layer.

FIG. 5B is a flow diagram 520 illustrating an adaptive diversity-based quantum architecture search method 520, according to example embodiments. In step 524, user device 102 and/or back-end computing system 104 may sample the search space for candidate circuits that attain the desired functionality for a given layer of the quantum circuit. This sampling may be random to obtain diverse circuit layer candidates at each iteration. In step 526, user device 102 and/or back-end computing system 104 may evaluate the candidate circuits for performance. This performance may be based metrics including but not limited to gate minimization and energy minimization. In step 528, user device 102 and/or back-end computing system 104 may rank the candidates according to their computed performance. User device 102 and/or back-end computing system 104 then selects the best candidates based on this ranking in step 530. If the circuit is complete in step 532, user device 102 and/or back-end computing system 104 may output the quantum circuit design in step 534. However, if the circuit is not complete in step 532, then user device 102 and/or back-end computing system 104 may add an additional layer to the circuit and repeats the steps for the additional layer in step 536. This process is repeated until the quantum circuit design is complete.

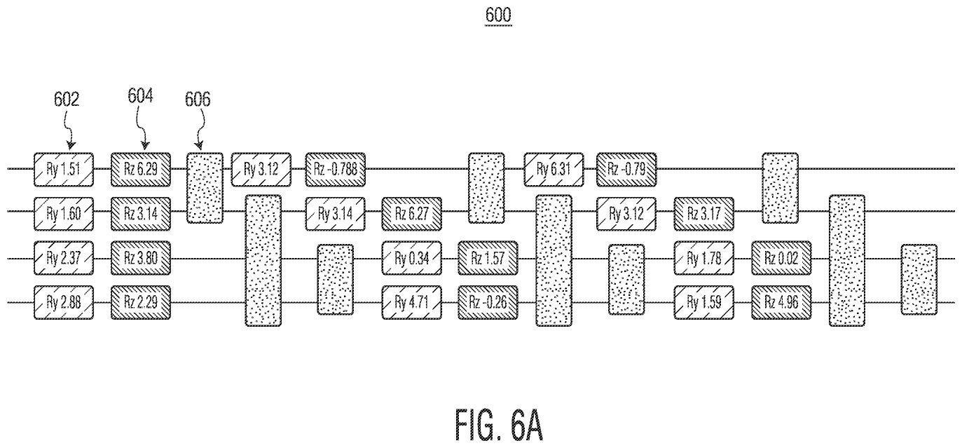

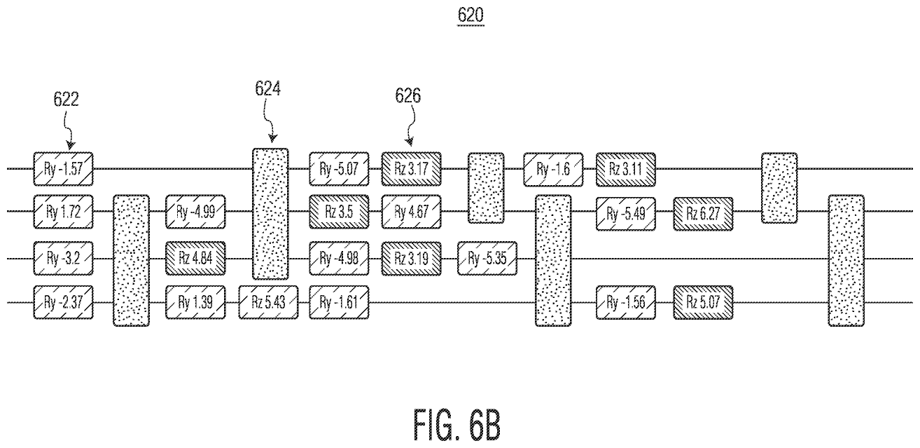

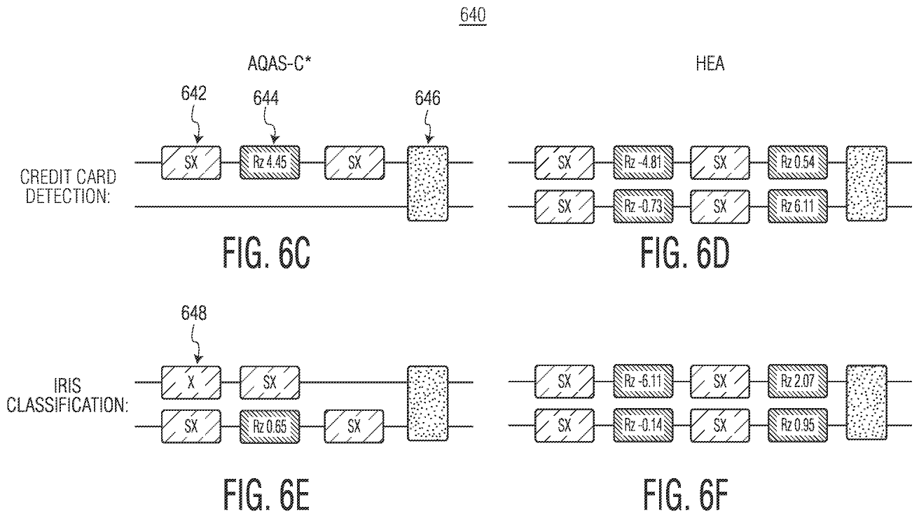

FIG. 6A is a block diagram 600 illustrating an optimized hardware efficient ansatz, according to example embodiments as implemented under the IBM-Lima simulator noise model, for the 4-qbit Heisenberg model. This ansatz may be optimized through the Adaptive diversity-based quantum architecture search algorithm, which aims to find the best quantum circuit for a specific task, in this case, the Heisenberg model. The ansatz may include multiple layers, each containing single-qbit gates that are parameterized by variables that can be adjusted and two-qbit gates such as rotational gates and CNOT gates. Specifically, the gates may include rotation gates 602 which rotate the qbit about the Y-axis, rotation gates 604 which rotate the qbit about the Z-axis, and CNOT gates 606 that perform NOT operations on the qbits.

FIG. 6B is a block diagram 620 illustrating an optimized quantum circuit, according to example embodiments. Block diagram 620 illustrates the best quantum circuit among the optimized quantum circuits generated by the Adaptive diversity-based quantum architecture search method, as implemented under the IBM-Lima simulator noise model, for the 4-qbits Heisenberg model. The gates utilized include rotation gates 622 which rotate the qbit about the Y-axis, CNOT gates 624 that perform NOT operations on the qbits, and rotation gates 626 which rotate the qbit about the Z-axis. It is noted that this circuit has a shallower depth and fewer parameters compared to the circuit shown in FIG. 6A.

FIG. 6C is a block diagram illustrating an optimized hardware efficient ansatz and an optimized hardware efficient quantum circuit for the use case of credit card fraud detection, according to example embodiments. FIG. 6D is a block diagram illustrating an optimized hardware efficient ansatz and an optimized hardware efficient quantum circuit for the use case of credit card fraud detection, according to example embodiments. FIG. 6E is a block diagram illustrating an optimized hardware efficient ansatz and an optimized hardware efficient quantum circuit for use case of Iris classification, according to example embodiments. FIG. 6F is a block diagram illustrating an optimized hardware efficient ansatz and an optimized hardware efficient quantum circuit for use case of Iris classification, according to example embodiments.

Specifically, FIGS. 6C-6F show the optimized hardware efficient ansatz and the best quantum circuit of optimized quantum circuits generated by the Adaptive diversity-based technique under the Lima simulator noise model for Iris classification and credit card fraud detection. The gates utilized may include six gates 642, rotation gates 644 which rotate the qbit about the Z-axis and CNOT gates 646 that perform NOT operations on the qbits and gates 648. In FIGS. 6C and 6D, the circuit designs are shown for credit card fraud detection, while in FIGS. 6E and 6F, the circuit designs are shown for Iris classification. The circuits in FIGS. 6C and 6E are optimized by the Adaptive diversity-based QAS method, while the HEA in FIGS. 6D and 6F is an optimized hardware efficient ansatz for each task.

As described above, FIG. 6A depicts the HEA design for the 2-D Heisenberg model, while FIG. 6B represents the AQAS-C design for the same 2-D Heisenberg model, and FIGS. 6C-6F showcases both the HEA and AQAS-C designs for Iris classification and fraud detection use cases. It is noted that these circuits differ in terms of their depths, with the AQAS-C designs being shorter relative to the HEA designs for each problem.

Furthermore, the circuit gates are chosen according to the application. Specifically, the Rz gate with parameter is a single qbit gate that applies a phase shift to the qbit state, rotating it around the Z-axis of the Bloch sphere, where the parameter effectively determines the amount of rotation. The Ry gate with parameter is another single qbit gate that applies a rotation around the Y-axis of the Bloch sphere where the parameter effectively determines the angle of rotation of the qbit. The SX gate is a single qbit gate known as the square root of X gate or the square root of NOT gate. The SX gate performs a rotation around the X-axis of the Bloch sphere. The unlabeled blocks 606, 624, and 646 represent the CNOT gate having the qbit on the top as the control qbit, and the qbit on the bottom as the target qbit. The CNOT gate is a two qbit gate where the target qbit is flipped if the control qbit is |1>. Of course, other gates may be selected for the quantum circuit based on the particular application and optimization goals.

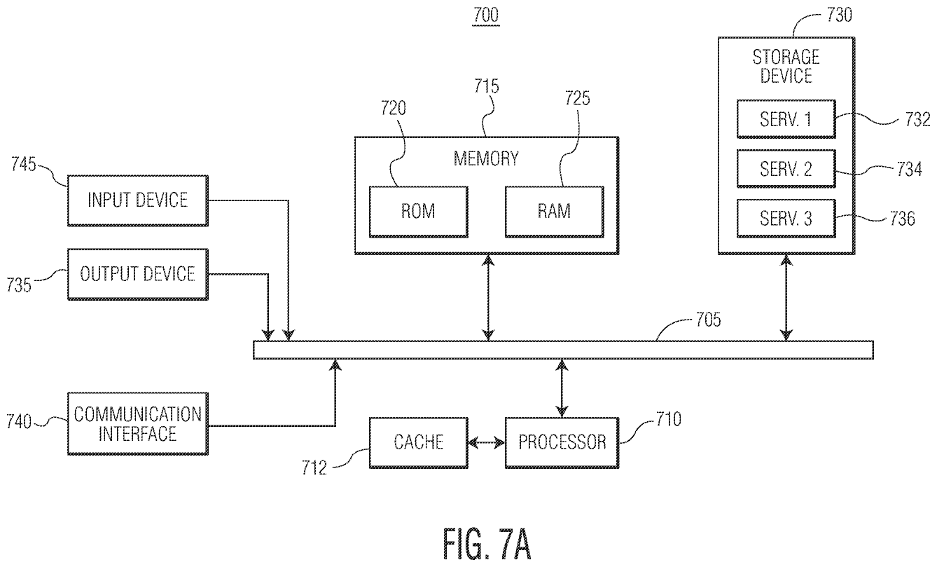

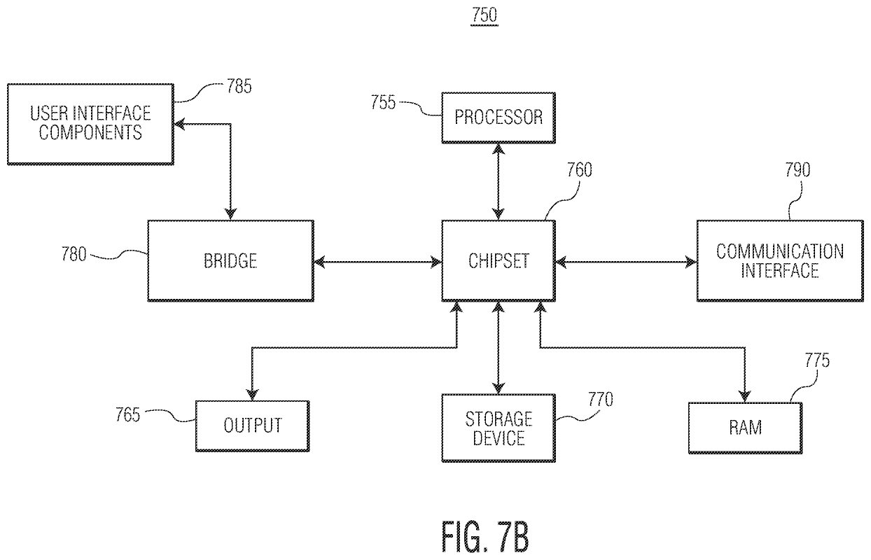

FIG. 7A illustrates a system bus architecture of computing system 700, according to example embodiments. System 700 may be representative of at least a portion of back-end computing system 104. One or more components of system 700 may be in electrical communication with each other using a bus 705. System 700 may include a processing unit (CPU or processor) 710 and a system bus 705 that couples various system components including the system memory 715, such as read only memory (ROM) 720 and random-access memory (RAM) 725, to processor 710. System 700 may include a cache of high-speed memory connected directly with, in close proximity to, or integrated as part of processor 710. System 700 may copy data from memory 715 and/or storage device 730 to cache 712 for quick access by processor 710. In this way, cache 712 may provide a performance boost that avoids processor 710 delays while waiting for data. These and other modules may control or be configured to control processor 710 to perform various actions. Other system memory 715 may be available for use as well. Memory 715 may include multiple different types of memory with different performance characteristics. Processor 710 may include any general-purpose processor and a hardware module or software module, such as service 1 732, service 2 734, and service 3 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system 700, an input device 745 may represent any number of input mechanisms, such as a microphone for speech, a touch-sensitive screen for gesture or graphical input, keyboard, mouse, motion input, speech and so forth. An output device 735 may also be one or more of a number of output mechanisms known to those of skill in the art. In some instances, multimodal systems may enable a user to provide multiple types of input to communicate with computing system 700. Communications interface 740 may generally govern and manage the user input and system output. There is no restriction on operating on any particular hardware arrangement and therefore the basic features here may easily be substituted for improved hardware or firmware arrangements as they are developed.

Storage device 730 may be a non-volatile memory and may be a hard disk or other types of non-transitory computer readable media which may store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 may include services 732, 734, and 736 for controlling the processor 710. Other hardware or software modules are contemplated. Storage device 730 may be connected to system bus 705. In one aspect, a hardware module that performs a particular function may include the software component stored in a computer-readable medium in connection with the necessary hardware components, such as processor 710, bus 705, output device 735, and so forth, to carry out the function.

FIG. 7B illustrates a computer system 750 having a chipset architecture that may represent at least a portion of back-end computing system 104. Computer system 750 may be an example of computer hardware, software, and firmware that may be used to implement the disclosed technology. System 750 may include a processor 755, representative of any number of physically and/or logically distinct resources capable of executing software, firmware, and hardware configured to perform identified computations. Processor 755 may communicate with a chipset 760 that may control input to and output from processor 755. In this example, chipset 760 outputs information to output 765, such as a display, and may read and write information to storage device 770, which may include magnetic media, and solid-state media, for example. Chipset 760 may also read data from and write data to RAM 775. A bridge 780 for interfacing with a variety of user interface components 785 may be provided for interfacing with chipset 760. Such user interface components 785 may include a keyboard, a microphone, touch detection and processing circuitry, a pointing device, such as a mouse, and so on. In general, inputs to system 750 may come from any of a variety of sources, machine generated and/or human generated.

Chipset 760 may also interface with one or more communication interfaces 790 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 755 analyzing data stored in storage device 770 or RAM 775. Further, the machine may receive inputs from a user through user interface components 785 and execute appropriate functions, such as browsing functions by interpreting these inputs using processor 755.

It may be appreciated that example systems 700 and 750 may have more than one processor 710 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method for generating quantum circuits, the method comprising:
a) sampling, by a processor, a search space for candidate quantum circuits for a circuit layer of a quantum circuit design;
b) evaluating, by the processor, performance of the candidate quantum circuits for the circuit layer;
c) selecting, by the processor, one of the candidate quantum circuits for the circuit layer based on the evaluated performance; and
d) adding, by the processor, an additional circuit layer based on the quantum circuit design to the selected one of the candidate quantum circuits.

2. The method of claim 1, further comprising:
repeating, by the processor, steps (a)-(d) until the quantum circuit design is complete.

3. The method of claim 1, further comprising:
setting, by the processor, the search space for the candidate quantum circuits based on a functionality of the circuit layer of the quantum circuit design.

4. The method of claim 1, wherein sampling, by the processor, the search space for the candidate quantum circuits for the circuit layer of the quantum circuit design comprises:
randomly sampling the search space for the candidate quantum circuits for the circuit layer of the quantum circuit design.

5. The method of claim 1, wherein evaluating, by the processor, the performance of the candidate quantum circuits for the circuit layer comprises:
computing a metric including at least one of energy usage and accuracy of the candidate quantum circuits.

6. The method of claim 5, wherein evaluating, by the processor, the performance of the candidate quantum circuits for the circuit layer comprises:
ranking, by the processor, the candidate quantum circuits based on the metric for each of the candidate quantum circuits.

7. The method of claim 1, wherein selecting, by the processor, the one of the candidate quantum circuits for the circuit layer based on the evaluated performance comprises:
selecting the one of the candidate quantum circuits determined to have a maximum performance among the candidate quantum circuits.

8. The method of claim 1, further comprising:
repeating, by the processor, steps (a)-(d) for the additional circuit layer, such that the evaluated performance is performed for a combination of the circuit layer connected to the additional layer.

9. The method of claim 1, further comprising:
setting, by the processor, the search space to include quantum gates to achieve a functionality of the circuit layer of the quantum circuit design.

10. The method of claim 1, further comprising:
setting, by the processor, the quantum circuit design as a variational quantum Eigensolver (VQE) algorithm or a variational quantum classifier (VQC) algorithm.

11. A non-transitory computer readable medium comprising one or more sequences of instructions, which, when executed by one or more processors, causes a computing system to perform operations comprising:
a) sampling, by the computing system, a search space for candidate quantum circuits for a circuit layer of a quantum circuit design;
b) evaluating, by the computing system, performance of the candidate quantum circuits for the circuit layer;
c) selecting, by the computing system, one of the candidate quantum circuits for the circuit layer based on the evaluated performance; and
d) adding, by the computing system, an additional circuit layer based on the quantum circuit design to the selected one of the candidate quantum circuits.

12. The non-transitory computer readable medium of claim 11, further comprising:
repeating, by the computing system, steps (a)-(d) until the quantum circuit design is complete.

13. The non-transitory computer readable medium of claim 11, further comprising:
setting, by the computing system, the search space for the candidate quantum circuits based on a functionality of the circuit layer of the quantum circuit design.

14. The non-transitory computer readable medium of claim 11, wherein sampling, by the computing system, the search space for the candidate quantum circuits for the circuit layer of the quantum circuit design comprises:
randomly sampling the search space for the candidate quantum circuits for the circuit layer of the quantum circuit design.

15. The non-transitory computer readable medium of claim 11, wherein evaluating, by the computing system, the performance of the candidate quantum circuits for the circuit layer comprises:
computing a metric including at least one of energy usage and accuracy of the candidate quantum circuits.

16. The non-transitory computer readable medium of claim 15, wherein evaluating, by the computing system, the performance of the candidate quantum circuits for the circuit layer comprises:
ranking, by the computing system, the candidate quantum circuits based on the metric for each of the candidate quantum circuits.

17. The non-transitory computer readable medium of claim 11, wherein selecting, by the computing system, the one of the candidate quantum circuits for the circuit layer based on the evaluated performance comprises:
selecting the one of the candidate quantum circuits determined to have a maximum performance among the candidate quantum circuits.

18. The non-transitory computer readable medium of claim 11, further comprising:
repeating, by the computing system, steps (a)-(d) for the additional circuit layer, such that the evaluated performance is performed for a combination of the circuit layer connected to the additional layer.

19. The non-transitory computer readable medium of claim 11, further comprising:
setting, by the computing system, the search space to include quantum gates to achieve a functionality of the circuit layer of the quantum circuit design.

20. A system comprising:
a processor; and
a memory having programming instructions stored thereon, which, when executed by the processor, causes the system to perform operations comprising:
a) sampling, by the system, a search space for candidate quantum circuits for a circuit layer of a quantum circuit design,
b) evaluating, by the system, performance of the candidate quantum circuits for the circuit layer,
c) selecting, by the system, one of the candidate quantum circuits for the circuit layer based on the evaluated performance, and
d) adding, by the system, an additional circuit layer based on the quantum circuit design to the selected one of the candidate quantum circuits.
